(19) United States
(12) Patent Application Publication
(10) Pub. No.: US 2011/0150604 A1
(43) Pub. Date: Jun. 23, 2011

(54) REPLACEABLE SHEAR BLADE FOR BOOK TRIMMING APPARATUS AND METHOD OF CHANGING SUCH BLADE

(76) Inventors: Jeffrey D. Marsh, Foristell, MO (US); Lynn W. Swenson, Johnsburg, IL (US)

(21) Appl. No.: 12/970,516

(22) Filed: Dec. 16, 2010

Related U.S. Application Data
(60) Provisional application No. 61/287,510, filed on Dec. 17, 2009.

(51) Int. Cl. B42B 9/00; B23P 11/00

(52) U.S. Cl. 412/16; 29/525.01; 29/402.08

(57) ABSTRACT

A replaceable shear blade for a book trimming apparatus, the latter comprising a shear carriage having the replaceable shear blade mounted thereon. The shear blade has a sharp cutting edge for shearing a book between an anvil and the cutting edge. The shear blade is removably mounted with respect to the shear carriage for replacement of the shear blade, where the shear blade is removably secured relative to the shear carriage by a plurality of fasteners accessible from above. A removable sheath encloses the cutting edge. At least one removable handle is secured to the shear blade so that the shear blade and the sheath may be handled as a unit, with this handle being grippable from above for installation of the shear blade on the shear carriage, and with the handle and the sheath being removable from the shear blade upon installation of the shear blade on the shear carriage. A method of installation and removal of the shear blade is also disclosed.

### CROSS-REFERENCE TO RELATED APPLICATIONS

This application relates to and claims priority to U.S. Provisional Patent Application No. 61/287,510 filed on Dec. 17, 2010, and incorporates this application by reference in their entirety.

### STATEMENT REGARDING FEDERALLY SPONSORED RESEARCH OR DEVELOPMENT

Not Applicable.

### BACKGROUND OF THE DISCLOSURE

As described in my above-noted U.S. patent application Ser. No. 12/576,923, which is herein incorporated by referent in its entirety, a shear blade 189 (referring to the reference characters in the aforesaid patent application and in FIG. 1 of the present disclosure), preferably a carbide blade, has an elongate sharp shear edge 191. The shear blade is removably mounted in a recess 199 in a shear blade carrier 185 and is held in place by bolts (not shown in FIG. 1) received in openings 195, 197. The shear blade edge 191 is exceedingly sharp. However, after shearing thousands or even tens of thousands of books, the cutting edge may become dull and would require replacement. Because access to the bolts holding the blade in place was from below, it was difficult for a technician to access these bolts to effect changing of the blade. In addition, the sharpness of the shear edge 191, posed a safety problem for the technician as he removed the blade from the book shear. Thus, there was a need to provide easier access to the bolts securing of the blade to the blade carriage and there was a need to protect the technician from the sharp edge both during both installation of a new blade and removal of a used blade.

### SUMMARY OF THE DISCLOSURE

A replaceable shear blade for a book trimming apparatus is disclosed. The book trimming apparatus comprises a shear carriage having the replaceable shear blade mounted thereon. The shear blade has a sharp cutting edge for shearing a book between an anvil and the cutting edge. The shear blade is removably mounted with respect to the shear carriage for replacement of the shear blade by a plurality of fasteners accessible from above. A removable sheath encloses the cutting edge. At least one removable handle is secured to the shear blade so that the shear blade and the sheath may be handled as a unit, with this handle being grippable from above the shear carriage for installation of the shear blade on the shear carriage, and with the handle and the sheath being removable from the shear blade upon installation of the shear blade on the shear carriage.

A method of installing a shear blade in a book shear is disclosed. This method involves fitting a sheath around a cutting edge of the shear blade so as to protect the cutting edge during installation. Then, the shear blade is installed in a recess in a shear carriage such that a rear face of the shear blade is in engagement with a rear shoulder of the shear carriage. The shear blade body is secured to the shear carriage by means of a plurality of fasteners accessible from above. Then, the sheath is removed from the shear blade.

Other objects and features of the disclosure will be in part apparent and in part pointed out hereinafter.

### BRIEF DESCRIPTION OF THE DRAWINGS

FIG. 1 is a view similar to FIG. 17 of U.S. patent application Ser. No. 12/576,923 illustrating a shear blade installed in a shear assembly for trimming a perfect bound book between the shear blade and an anvil;

FIG. 2 is a perspective top view of a book shear assembly similar to the shear assembly shown in FIG. 1 illustrating the system for the installation and removal of the shear blade while the cutting edge of the shear blade is enclosed in a sheath to protect the technician changing the blade and to protect the blade, and illustrating that the fasteners holding the blade are accessible from above;

FIG. 3A is a vertical sectional view taken along line 3-3 of FIG. 2 illustrating the system for the installation and removal of the shear blade while the cutting edge of the shear blade is enclosed in a sheath to protect the cutting edge and the technician changing the blade and illustrating that the fasteners holding the blade are accessible from above;

FIG. 3B is a view similar to FIG. 3A illustrating in cross section an eccentric adjustment fastener installed in the replaceable blade body for aiding in positioning the blade body and the blade carried thereby relative to the blade carrier and relative to the anvil against which the book it to be sheared;

FIG. 4 is an exploded perspective view on an enlarged scale of the replaceable shear blade and its sheath; and

FIG. 5 is a cross sectional view of an eccentric adjustment fastener installed in an eccentric hole in the replaceable blade body for aiding in positioning the replaceable blade.

Corresponding reference characters indicate corresponding parts throughout the several views of the drawing.

### DESCRIPTION OF PREFERRED EMBODIMENTS

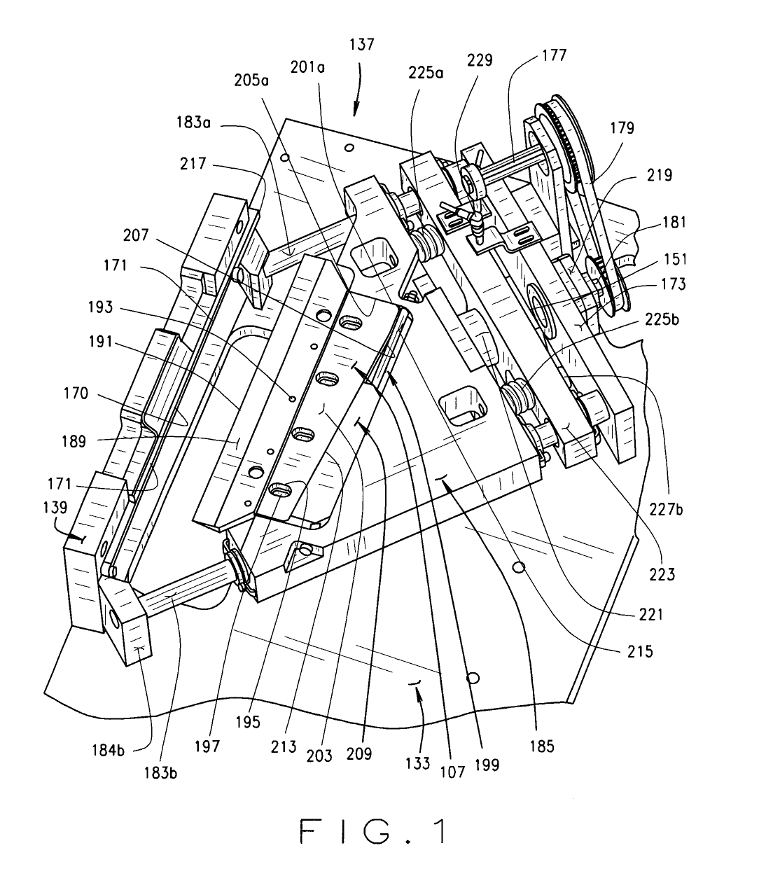

Referring now to the drawings and particularly to FIG. 1, a book trimming station is indicated in its entirety by reference character 61. This book trimming station is similar to the book trimming station disclosed in the above-discussed U.S. patent application Ser. No. 12/576,923, filed on Oct. 9, 2009, which is herein incorporated by reference in its entirety. Reference should be made to this '923 application for a full description of the trimming station 61. In this disclosure, some of the more salient features of the trimming station will be disclosed in order to specifically describe certain features that may be important to the understanding of the present disclosure. However, reference nevertheless should be made to the above-noted '923 application for a more complete description. It will be understood that reference characters below number 500 refer to structure described in the above-noted '923 U.S. patent application and that reference characters above 500 refer to newly disclosed subject matter described herein. However, it will be understood that the subject matter described in the above-noted '923 application is not prior art with respect to the instant application just because it was first disclosed in the above-noted application.

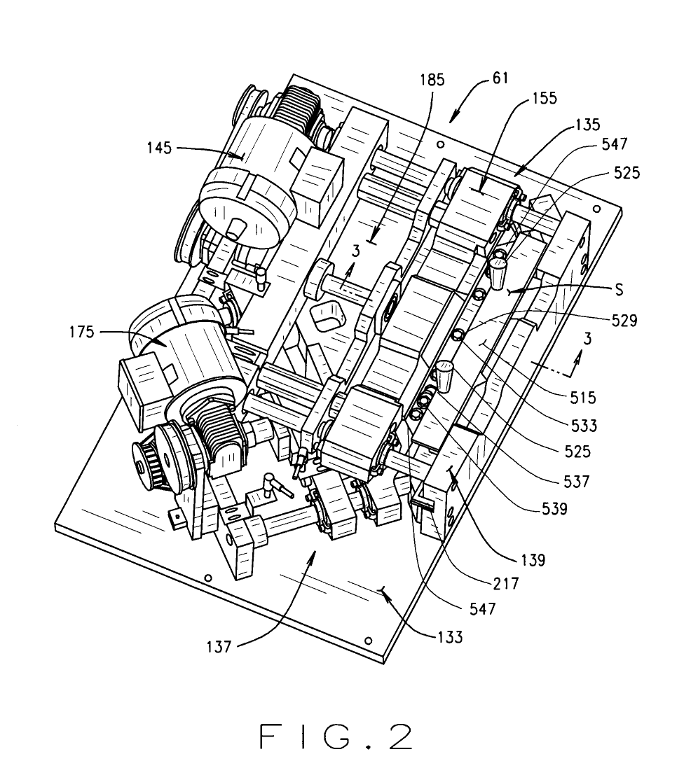

As shown in FIG. 2, trimming station 61 includes a book clamp 135 and a book shear 137 mounted on a frame bed 133. The book clamp 135 clamps a book B, as shown in FIG. 15 of the above identified application, between a stationary, fixed anvil 139 and a movable clamp member 155 by means of clamp motor 145 and its drive. The details of the clamp drive and motor are fully disclosed in the above-noted patent application. Further, shear 137 includes a shear carriage 185 mounting a shear blade 189. The shear carriage and shear blade are movable by a shear motor 175 and its associated drive between a retracted position in which the cutting edge 191 of shear blade 189 is clear of a book clamped on anvil 139 by book clamp 135 and a shearing position in which the shear blade shears through such book.

Blade 189 is preferably a carbide blade having a sharp shearing or cutting edge 191. In order to shear books, this shearing edge must be exceedingly sharp. Because the preferred blade is a carbide blade, it remains sharp so that it may shear thousands and perhaps tens of thousands of books. However, the cutting edge will eventually become dull and need to be changed. The number of books that blade 189 may shear before its cutting edge 191 dulls is somewhat dependent on the paper used for the book block and the covers of the books being printed and sheared. It will be understood that some paper stocks may be somewhat more abrasive than other papers and that the more abrasive papers may cause more wear on the blade. Also, such carbide blades are fragile and may be subject to breakage or nicking of the cutting edge for a variety of reasons. Accordingly, it may be necessary to change blade 189 from time to time so as to insure that the shear 137 satisfactorily shears the books.

As shown in FIG. 17 of in the above-noted patent application, the shear blade 189 is removably secured to the shear blade assembly 187 by bolts (not shown in FIG. 17). The shear blade assembly 187 has a plurality (e. g., four) of elongate slots 195 that extend generally perpendicular to blade edge 191. These elongate slots in the blade assembly cooperate with mating elongate slots 197 in the blade carrier 185 and receive bolts (not shown). These elongate slots and the bolts permit the shear blade assembly 187 to be precisely positioned within the shear blade carrier 185 so that the cutting edge 191 of blade 189 uniformly contacts the book along the width of the book side to be sheared. The blade is firmly held in place relative to blade carrier 185 when the bolts (again, not shown in FIG. 17 of the above-noted application) in slots 195, 197 are tightened. However, it was necessary for the technician changing the blade to access these bolts from below to loosen these bolts so that an old blade may be removed. It was also necessary for the technician to access these bolts from below to tighten these bolts upon the installation of a new blade. This either required two technicians to change the blade or required a technician positioned below the blade carriage to reach between the anvil and the cutting edge 191 of blade 189 to access the bolts. This exposed cutting edge posed a hazard to the technician both on installing and removing the blade. In addition, because the preferred blade 189 was a carbide blade, it was subject to breaking or nicking upon installation.

In accordance with the present disclosure, an improved blade installation and removal procedure is disclosed in which the bolts 502 securing the blade in place on the blade carriage 185 are accessible from above and in which the cutting edge 191 of the blade 189 is protected within a sheath S, as shown in FIGS. 2-4, as the blade assembly is installed or removed. This sheath S is preferably made of a suitable plastic material, such as High Density Polyethylene (HDPE), or other suitable plastic or other frangible.

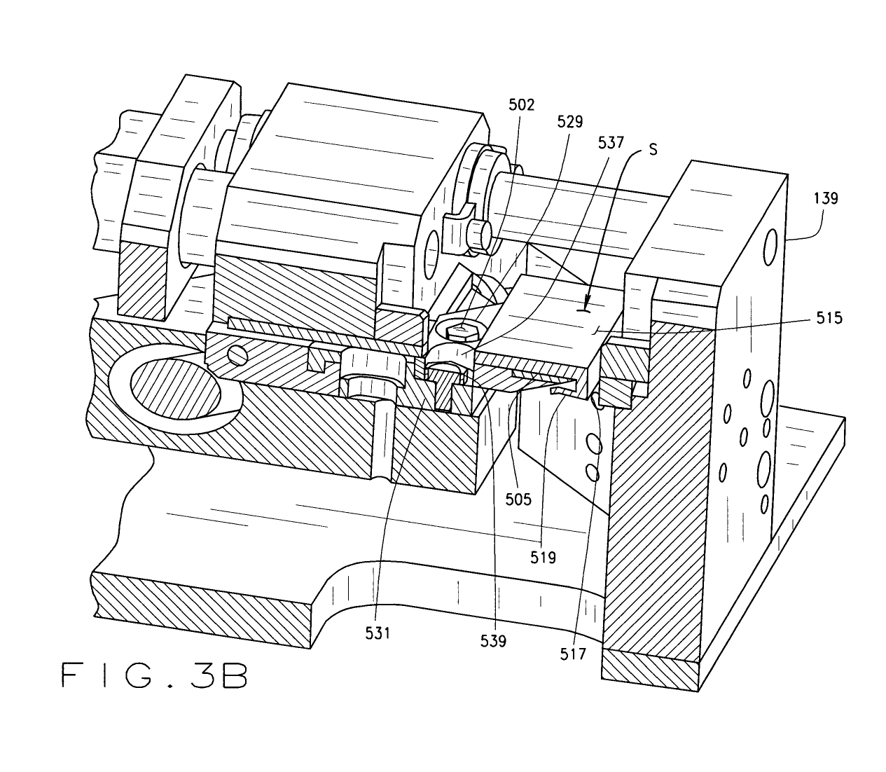

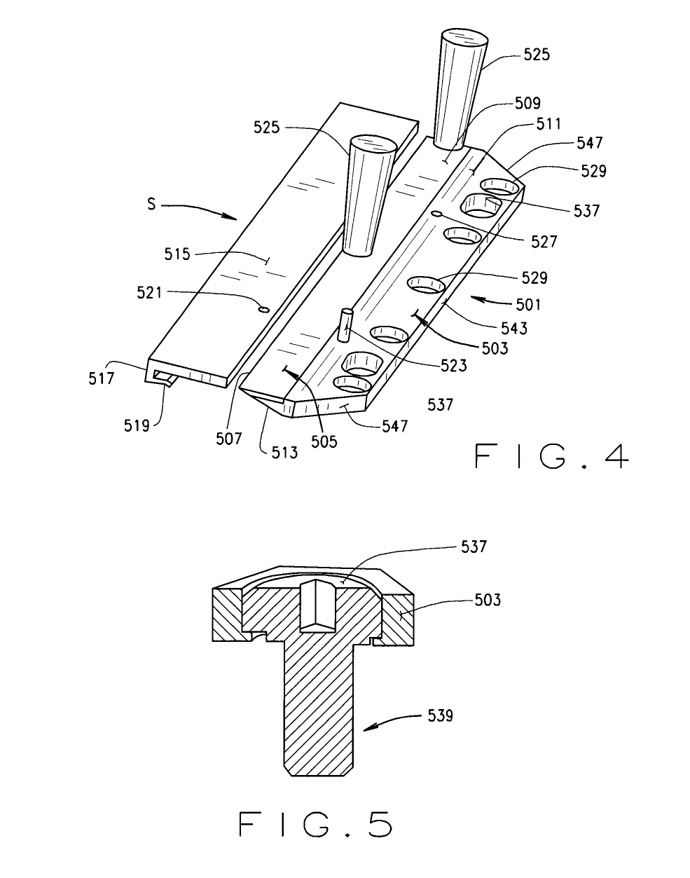

Referring to FIG. 4, a replaceable shear blade assembly, as generally indicated at 501, is shown. This replaceable shear blade assembly comprises a blade body 503, preferably of a suitable carbon steel material or the like, to which a carbide blade insert 505 is adhered by a suitable adhesive as is well known in the art. Preferably, blade insert 505 is of a suitable carbide material, such as a tungsten carbide material commercially available from Alliance Knife Co. of Germany, which is inlaid or bonded to the carbon steel blade body 503. Blade insert 505 has a sharp cutting edge 507 facing forward toward anvil 139. As shown best in FIG. 4, blade insert 505 has a flat, planar top horizontal surface 509 that is generally co-planar with the top surface 511 of blade body 503 when the blade body is installed in blade carriage 185. Further, blade insert 507 and blade body 503 have a wedge-shaped or inclined lower surface 513 angling upwardly toward cutting edge 507 to form the cutting edge. It will be understood that as cutting edge 507 shears through a book B held between the clamp member 155 and anvil 139, this angled lower surface pushes the sheared margin of the book downwardly away from the underside of the blade insert and the blade body.

As previously noted, the cutting edge 507 of blade insert 505 is preferably enclosed or protected by a plastic sheath S, as shown in FIGS. 2-4. This sheath S has an upper surface 515, a front, vertical portion 517 disposed in front of cutting edge 507, and a lower portion 519 underlying the blade insert so that the full length of the cutting edge is enclosed within the sheath. It will be appreciated that the lower portion 519 of the sheath may be formed so as to resiliently grip the lower surface 513 of the blade body 503 so as to aid in holding the sheath in its protective position as the blade is shipped and as the blade is handled at the installation site.

As indicated at 521 in FIG. 4, the upper surface 515 of sheath S has a pair of spaced holes therein for receiving a threaded stud 523 protruding from a respective handle 525, where the stud is received in a respective threaded hole 527 in the upper face of blade body 503 so as to secure the handles to the blade body and to hold the sheath in position on blade assembly 501. Handles 525 allow the technician to readily handle the replaceable blade (which may weigh several pounds) during installation and removal of the blade from the blade carriage, and the technician is protected from the sharp cutting edge 507 by the sheath S.

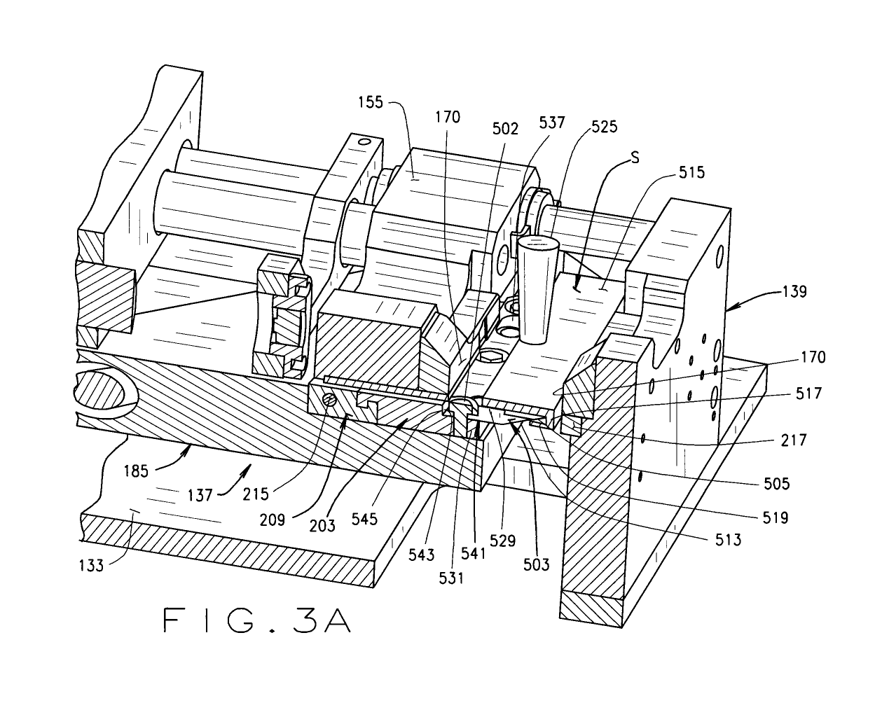

Blade body 503 has a plurality of circular bolt holes 529 (five such bolt holes are shown) in the rear portion of the blade body. These bolt holes 529 are aligned with threaded bolt holes 531 in blade mounting body 203, which is similar to body 203 described in the afore-mentioned '923 application. The bolt holes 529 are preferably countersunk so that when bolts or fasteners 533 (as shown in FIG. 3) are inserted from above the heads of the bolts are below the upper surface of the blade body. The shanks of these fasteners threadably engage their respective threaded hole 531 in blade mounting body 203. As shown in FIG. 3. In addition, two spaced eccentric holes 537 are provided in blade body 503 for receiving a respective eccentric, adjustable fastener, as generally indicated at 539.

Blade body 503 is received in a recess 541 provided in blade mounting body 203. It will be understood that the eccentric fasteners 539 may be used to accurately position the blade assembly 501 within recess 541 so that a rear edge 543 of blade body 503 is in abutting relation with a forward facing shoulder 545 of recess 541 in blade mounting body 203, as shown in FIG. 3. It will be understood that rear edge 543 is parallel to the shear surface of anvil 139 such that when rear edge 543 is in abutting relation with shoulder 545, cutting edge 507 is substantially parallel to the cutting surface of anvil 139. However, it may be desired to use the adjustable eccentric fasteners 539 to precisely adjust the blade edge 507 to be parallel to the cutting surface or cutting stick 217 of anvil 139. With the blade body 503 so positioned in recess 541, bolts 533 are tightened, the blade assembly 501 is secured in position relative to body 203.

In accordance with the present disclosure, in order to install blade assembly 501 in shear carriage 185, the clamp jaw 155 is moved to a retracted position clear of anvil 139 and shear carriage 185 is advanced to approximately its position shown in FIG. 2 or 3 such that the blade assembly 501 is clear from above. Assuming that no blade assembly is installed on blade carriage 185, the new blade assembly is removed from its shipping container (not shown). Preferably, sheath S is shipped with each new blade assembly and the sheath is installed over the cutting edge 507 of blade insert 505 so as to protect the blade during shipping. While handles 525 may be shipped installed on the blade assembly, it may be preferable that the handles are removed from the new blade assembly within its shipping container or box. If that is the case, before the blade assembly is removed from its shipping container, the handles 525 are installed by inserting handle studs 523 (which are preferably installed on the handles) through holes 521 in sheath S and are threadably engaged in holes 527 in blade body 503. With the handles 525 so installed, sheath S is fixedly held in place on blade assembly 501 in such manner that it cannot be inadvertently dislodged from the blade insert 505 during installation of the blade assembly. In this manner, cutting edge 507 remains covered during installation of the blade until the sheath S is removed. It will be further appreciated that the handles 525 allow the technician to readily hold the blade assembly as it is positioned within recess 541 in blade mounting body 203.

As previously noted, eccentric fasteners 539 are inserted in eccentric holes 537 in blade mounting body 203 so as to insure that blade body 503 is properly positioned within recess 541 with its rear wall 543 in firm engagement with shoulder 545 of the blade mounting body 203. As noted, this insures that cutting edge 507 is parallel to the cutting surface of anvil 139. In addition, recess 541 may be provided with side walls 547 of recess 541 (as shown in FIG. 2) which abut corresponding side walls 549 (see FIG. 4) of blade mounting body 203 so as to effectively prevent side-to-side shifting or movement of blade assembly 501 with respect to the blade mounting body 203.

Once blade assembly 501 has been so installed on blade carriage 185 (and more precisely has been installed in recess 541 of blade mounting body 203), handles 525 may be unscrewed so as to remove the handles and their respective studs 523 from blade mounting body 503. Then, sheath S may be slipped off blade insert 505 so as to expose cutting edge 507 and the sheath is removed from the trimming station. Alternatively, sheath S may remain in place and the shear carriage 185 may be extended toward anvil 139 so that the cutting edge 507 may forcefully shear the front, vertical portion 517 of the sheath between the cutting edge and the anvil so that a portion of the sheath below a shear line approximately halfway down the sheath portion 517 so that the sheared portion will drop into the waste chute of the book trimming station 61. Then, as the shear carriage is moved toward its retracted position, the rear edge of the top portion 515 of sheath S will engage the clamp surface 170 of clamp bar 155. Because the sheath is no longer held in position by handles 525, this retraction of the shear carriage will sweep the remaining upper portion 515 of the sheath from the blade assembly and this upper portion will also be discarded into the waste chute. In this manner, the cutting edge 507 is not exposed at any time during the installation of the blade assembly 501.

In order to remove the blade assembly 501, the above-described process is reversed. Specifically, to remove the blade assembly the clamp bar 155 is moved to a retracted position, such as shown in FIG. 2 so that the blade assembly and the fasteners 529 and 539 are accessible from above. Then, a new sheath S is positioned around the cutting edge 507, as shown in FIG. 3, and handles 525 are installed so that the handle studs 523 are inserted through holes 521 in the upper portion 515 of the sheath and are threadably engaged in holes 527 in the blade mounting body 503. Then fasteners 529 and 539 may be then removed from above and the entire blade assembly and the sheath may be removed from the shear carriage from above as a unit. Again, except during installation of sheath S on cutting edge 507, the cutting edge is enclosed by and protected by the sheath during removal of the blade assembly.

As indicated at 209 in FIG. 3, the rear edge of mounting body 203 is in camming engagement with cam 209 so that the position of cutting edge 507 of blade assembly 501 may be accurately adjusted toward and away from anvil 139. As described in the afore-mentioned '923 application, cam 209 may be adjusted by means of a cam actuation screw 215.

As various changes could be made in the above constructions without departing from the broad scope of the invention, it is intended that all matter contained in the above description or shown in the accompanying drawings shall be interpreted as illustrative and not in a limiting sense.

1. A replaceable shear blade for a book trimming apparatus, the latter comprising a shear carriage having said replaceable shear blade mounted thereon, said shear blade having a sharp cutting edge for shearing a book between an anvil and said cutting edge, said shear blade being removably mounted with respect to said shear carriage for replacement of said shear blade, said shear blade being removably secured relative to said shear carriage by a plurality of fasteners accessible by a person installing or removing said shear blade, a removable sheath enclosing said cutting edge, at least one removable handle secured to said shear blade so that said shear blade and said sheath may be handled as a unit, said at least one handle being grippable from by a person for installation of said shear blade on said shear carriage, said at least one handle and said sheath being removable from said shear blade upon installation of said shear blade on said shear carriage.

2. A replaceable shear blade as set forth in claim 1 wherein said at least one handle secures said sheath to said blade such that upon removal of said at least one handle from said blade said sheath may be removed from said blade.

3. A replaceable shear blade as set forth in claim 1 wherein said shear blade has a plurality of fastener openings therein clear of said sheath for receiving said fasteners so as to secure said shear blade to said shear carrier.

4. A replaceable shear blade as set forth in claim 3 further having at least one eccentric cam adjustment for adjustably positioning said shear blade relative to said shear carriage so that said cutting edge of said shear blade is properly positioned relative to said shear carriage for shearing said book.

5. A replaceable shear blade as set forth in claim 1 wherein said sheath comprises an upper portion overlying the upper portion of said shear blade, a portion positioned in front of said cutting edge, and another portion underlying at least a portion of said shear blade adjacent said cutting edge such that said sheath encloses said cutting edge.

6. A replaceable shear blade as set forth in claim 5 wherein upon installation of said shear blade on said carriage and upon removal of said handle, actuation of said book trimming apparatus said portion of said sheath enclosing said cutting edge is sheared between said cutting edge and said anvil and upon retraction of said shear carriage said portion of said sheath overlying the upper portion of said shear blade is cleared from said shear blade.

7. A replaceable shear blade for a book trimming apparatus, the latter comprising a shear carriage having said replaceable shear blade mounted thereon, said shear blade having a blade body and a blade insert mounted in said blade body, said blade insert having a sharp cutting edge for shearing a book positioned between an anvil and said cutting edge, said shear carriage and shear blade assembly being movable between a retracted position in which said cutting edge is clear of a book positioned between an anvil and said cutting edge and a trimming position in which said cutting edge shears through said book, said shear blade being removably mounted with respect to said shear carriage for replacement of said shear blade, said blade assembly being removably secured relative to said shear carriage body by a plurality of accessible fasteners, a removable blade sheath enclosing said cutting edge, at least one removable handle secured to said blade body so that said shear blade and said sheath may be handled as a unit for installation on said blade carriage without exposure of said cutting edge, said at least one handle being grippable by a person for installation of said shear blade on said shear carriage, said at least one handle and said blade sheath being removable from said shear blade upon installation of said shear blade on said shear carriage.

8. A replaceable shear blade as set forth in claim 7 wherein said blade insert is of a carbide material and is mounted to said blade body, and wherein said blade insert has a horizontal top surface and a bottom surface angling toward one another with the intersection of these last-said surfaces forming said cutting edge.

9. A replaceable shear blade as set forth in claim 7 wherein said trimming apparatus further comprises a book clamp positioned relative to said shear blade, the latter having a clamp member movable toward and away from said anvil so as to clamp a book in position relative to said anvil while said book is trimmed, said clamp member having a bottom face slidingly engageable with one face of said shear blade proximate said book as said shear blade shears said book thereby to support said shear blade against upward movement as said shear blade shears said book.

10. A replaceable shear blade as set forth in claim 7 further comprising a blade mounting body carried by said carriage, said blade mounting body having a recess in its end toward said anvil with said blade mounting body recess receiving said blade body, said blade mounting body recess having a vertical shoulder substantially parallel to said anvil, said blade body having a rear edge engageable with said vertical shoulder, said mounting body further having a plurality of holes therein for receiving said fasteners for mounting said blade body within said blade mounting body recess.

11. A replaceable shear blade as set forth in claim 11 wherein at least two of said fasteners are eccentric cam fasteners for angularly positioning said blade body within said blade mounting body recess such that said rear edge of said blade body is in engagement with said vertical shoulder.

12. A replaceable shear blade as set forth in claim 11 wherein said blade mounting body has a plurality of threaded holes therein for receiving said fasteners.

13. A replaceable shear blade as set forth in claim 12 wherein said shear carriage has a carriage recess in its end disposed toward said anvil for reception of said blade mounting body, said carriage recess having a rear vertical end opposite said end disposed toward said anvil.

14. A replaceable shear blade as set forth in claim 13 having a cam interposed between said rear vertical end of said carriage recess and a rear vertical end of said blade mounting body such that actuation of said cam moves said blade mounting body toward or away from said anvil.

15. A method of installing a shear blade in a book shear comprising the steps of:
a. fitting a sheath around a cutting edge of said shear blade so as to protect said cutting edge during installation, said shear blade having a blade body;
b. installing said shear blade body in a recess in a shear carriage such that a rear face of said shear blade is in engagement with a rear shoulder of said shear carriage;
c. securing said shear blade body to said shear carriage by means of a plurality of fasteners; and
d. removing said sheath from said shear blade.

16. The method of claim 16 further comprising the steps of:
e. providing at least one removable handle on said shear blade for allowing ease of handling of the shear blade during installation; and
f. removing said handle from said shear blade after installation of said shear blade.

17. The method of claim 16 further comprising the steps of:
g. removing a shear blade previously installed by first installing a sheath on said shear blade to enclose shear cutting edge;
h. attaching one or more handles to said shear blade so that said shear blade may be handled by a person;
i. removing said fasteners from said blade body and from said shear carriage; and
j. removing said shear blade from said book shear.
